(19) United States
(12) Patent Application Publication
(10) Pub. No.: US 2018/0202239 A1
(43) Pub. Date: Jul. 19, 2018

(54) COMPLIANT MODULE CONNECTIONS

(71) Applicant: Schlumberger Technology Corporation, Sugar Land, TX (US)

(72) Inventors: Keith Moriarty, Houston, TX (US); Pratik Halani, Sugar Land, TX (US)

(73) Assignee: Schlumberger Technology Corporation, Sugar Land, TX (US)

(21) Appl. No.: 15/744,089

(22) PCT Filed: Jul. 13, 2016
(86) PCT No.: PCT/US2016/041955

§ 371 Date: Jan. 12, 2018

Related U.S. Application Data
(60) Provisional application No. 62/191,815, filed on Jul. 13, 2015.

(51) Int. Cl. E21B 17/02; H01R 13/52

(52) U.S. Cl. CPC E21B 17/028; H01R 13/5219

(57) ABSTRACT

Systems capable of compliantly coupling electrical assemblies located within drill string modules or drill collars to one another can include male and female mating portions, wire-carrying hollow tubes including helical portions thereof, a plurality of wires, and interconnection systems for interconnecting the plurality of wires. Related methods can include manufacturing the drill string modules and various components thereof, coupling the drill string modules to one another, and tripping the drill string modules into a wellbore.

### CROSS-REFERENCE TO RELATED APPLICATIONS

The present application claims priority to U.S. Provisional Application 62/191,815 filed Jul. 13, 2015, the entirety of which is incorporated by reference.

### FIELD OF THE INVENTION

Some embodiments described herein generally relate to systems and apparatuses that allow modules of drill strings or bottomhole assemblies (BHA) to be securely and efficiently coupled, physically, electrically, hydraulically, or otherwise, to one another, such that the coupling can be reliably maintained between modules during drilling. Additional embodiments generally relate to methods of using such systems and apparatuses to drill holes in the earth.

### BACKGROUND

In the drilling of oil and gas wells, a drill string can be made of various different modules and can include a bottomhole assembly also made of various different modules. Drill strings and bottomhole assemblies are often formed from multiple individual modules to reduce the cost associated with lost or damaged modules and to provide the drill string or bottomhole assembly with greater flexibility and functionalities to drill various trajectories, acquire various measurements regarding the wellbore or formations in a reservoir, and to conform to curves or other features of a bore hole.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one non-limiting embodiment, a compliant module connection system can include a first module and a second module. The first module can include a first drill collar, a first electric component, a first hollow tube decoupled from the first drill collar along an entire length of the first hollow tube, a first wire that is electrically coupled to the first electrical component and that extends through the first hollow tube, and a first portion of a module connection system. The second module can include a second drill collar, a second electric component, a second hollow tube decoupled from the second drill collar along an entire length of the second hollow tube, a second wire that is electrically coupled to the second electrical component and that extends through the second hollow tube, and a second portion of the module connection system. The second portion of the module connection system can be complementary to the first portion of the module connection system, and the first hollow tube can include a helical portion of the first hollow tube.

In another non-limiting embodiment, a method of making compliant module connections can include positioning a first electric component within a first drill collar of a first module, electrically coupling a first wire to the first electric component, and running the first wire through a first hollow tube decoupled from the first drill collar along an entire length of the first hollow tube. The method can further include positioning a second electric component within a second drill collar of a second module, electrically coupling a second wire to the second electric component, and running the second wire through a second hollow tube decoupled from the second drill collar along an entire length of the second hollow tube. The method can further include physically connecting the first module to the second module, thereby electrically coupling the first wire to the second wire.

### BRIEF DESCRIPTION OF THE DRAWINGS

In the drawings, sizes, shapes, and relative positions of elements are not drawn to scale. For example, the shapes of various elements and angles are not drawn to scale, and some of these elements may have been arbitrarily enlarged and positioned to improve drawing legibility.

FIG. 1 depicts a drilling rig and drill string according to one or more embodiments disclosed herein;

FIG. 2 depicts a module of a drill string including a female portion of a male-female connection system according to one or more embodiments disclosed herein;

FIG. 3 depicts a module of a drill string including a male portion of a male-female connection system according to one or more embodiments disclosed herein;

FIG. 4 depicts the female portion of FIG. 2 coupled to the male portion of FIG. 3 according to one or more embodiments disclosed herein;

FIG. 5 depicts a portion of a drill string including a male-female connection system according to one or more embodiments disclosed herein;

FIG. 6 depicts components of the drill string of FIG. 5, including a coiled tube thereof, according to one or more embodiments disclosed herein;

FIG. 7 depicts components of the drill string of FIG. 5, including a multi-contact electrical connector assembly thereof, according to one or more embodiments disclosed herein;

FIG. 8 depicts a module of a drill string including a female portion of a male-female connection system according to one or more embodiments disclosed herein;

FIG. 9 depicts a module of a drill string including a male portion of a male-female connection system according to one or more embodiments disclosed herein;

FIG. 10 depicts the female portion of FIG. 8 coupled to the male portion of FIG. 9 according to one or more embodiments disclosed herein;

FIG. 11 depicts a telescopic joint of a hollow tube according to one or more embodiments disclosed herein; and

FIG. 12 depicts a tube- or collar-length adjustment mechanism according to one or more embodiments disclosed herein.

### DETAILED DESCRIPTION

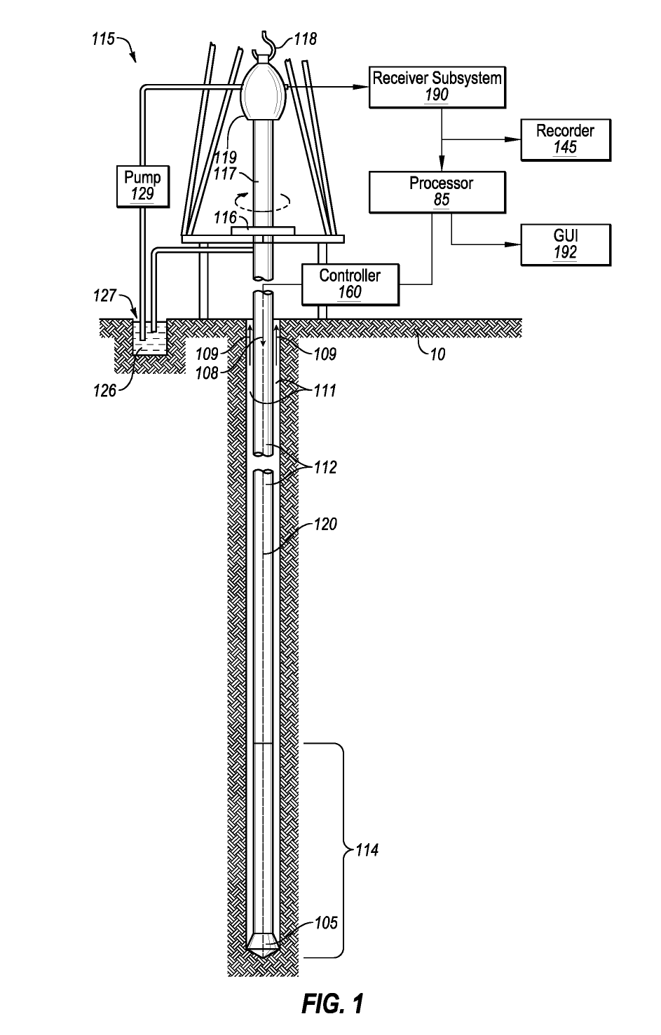

FIG. 1 illustrates a land-based platform and drilling rig 115 positioned over a wellbore 111, and a drill string 112 (on-bottom) for drilling the wellbore 111 into a formation 10. In the illustrated embodiment, the wellbore 111 is formed by rotary drilling. Those of ordinary skill in the art given the benefit of this disclosure will appreciate, however, that the subject matter of this disclosure also finds application in directional drilling applications as well as rotary drilling, and is not limited to land-based rigs.

The drill string 112 is suspended within the wellbore 111 and includes a bottomhole assembly 114 including a drill bit 105 at its lower, terminal, or bottom end. The drill string 112 is rotated by a rotary table 116, energized by means not shown, which engages a kelly 117 at the upper end of the drill string 112. The drill string 112 is suspended from a hook 118, attached to a travelling block (also not shown), through the kelly 117 and a rotary swivel 119 which permits rotation of the drill string 112 relative to the hook 118. Although depicted with a kelly 117 and rotary table 116 in FIG. 1, in some embodiments, the drill string 112 may be rotated using other methods, such as by using a topdrive.

Drilling fluid 126 (also referred to as drilling mud) is stored in a pit 127 formed at the well site. A pump 129 delivers the drilling fluid 126 to the interior of the drill string 112 via a port in the swivel 119, inducing the drilling fluid 126 to flow downwardly through the drill string 112 as indicated by the directional arrow 108. The drilling fluid 126 exits the drill string 112 via ports in the drill bit 105, and then circulates upwardly through the region between the outside of the drill string 112 and the wall of the wellbore 111, called the annulus, as indicated by the direction arrows 109. In this manner, the drilling fluid 126 lubricates the drill bit 105 and carries formation cuttings up to the surface as drilling fluid 126 returns to the pit 127 for recirculation.

One or more wires 120, such as wires carrying power or data, can extend along the length of the drill string 112. The wires 120 can carry data between a receiver subsystem 190, which can be communicatively coupled to a computer processor 85 and a recorder 145, and components of the drill string 112 located down-hole. Such an arrangement can be referred to as “wired drill pipe,” and alternative arrangements can also be used, such as wireless data transmission arrangements including mud pulse and electromagnetic telemetry arrangements. The computer processor 85 may be coupled to a monitor, which can employ a graphical user interface (“GUI”) 192 through which information can be graphically or otherwise presented to the user. The computer processor 85 can also be communicatively coupled to a controller 160. The controller 160 can serve multiple functions, in particular to control operation of the drill string 112 and the bottomhole assembly 114 at a terminal end thereof. Although depicted at the surface, the controller 160 and computer processor 85 may be arranged in any suitable manner. For example, the controller 160 and/or computer processor 85 may be part of the drill string 112.

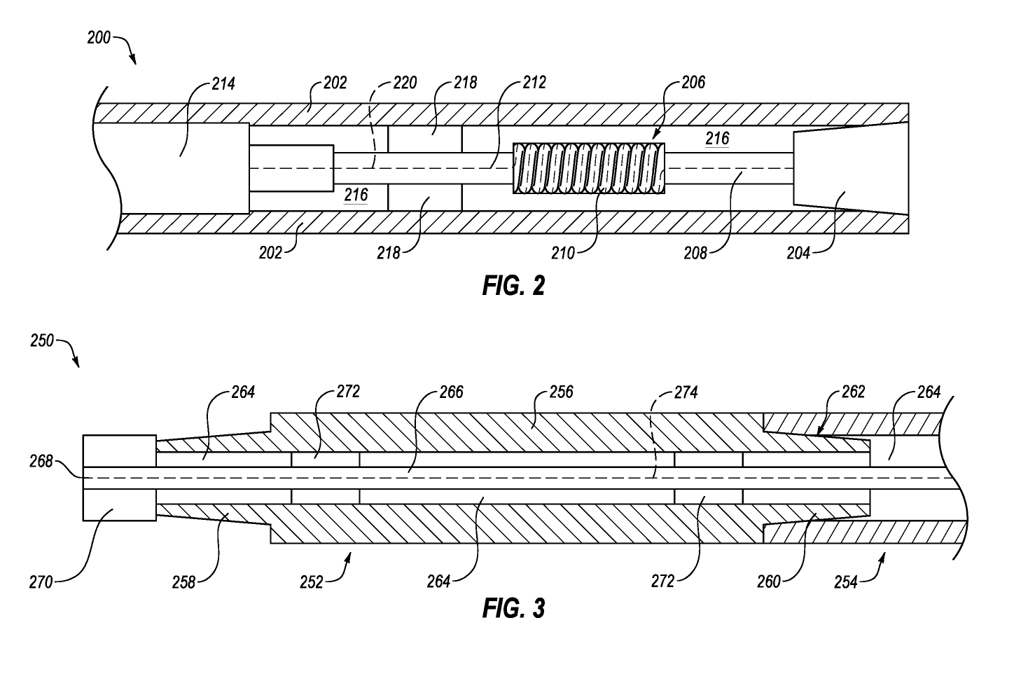

FIG. 2 illustrates a portion of a female module 200 of a drill string, such as for use in the drill string 112. The portion of the female module 200 illustrated in FIG. 2 can be either a bottom end or a top end of the female module 200 when it is positioned within a wellbore for a drilling operation. Female module 200 includes an outer shell or casing or drill collar 202 which houses other components of the module 200. For example, the drill collar 202 can house a female portion 204 of a male-female connection system at a first end of the female module 200.

The female portion 204 can include an open space at the end of the female module 200 that can receive a complementary mating portion of a male module, e.g., as described in greater detail below. The open space of the female portion 204 can have a relatively wide opening at the end of the female module 200 and can be tapered inward toward a center of the female module 200, such that the inside diameter of the female portion decreases moving away from the relatively wide opening. The inner surface of the drill collar 202 at the first end of the female module, that is, the outer boundary of the female portion 204, can be threaded so as to facilitate the mating of the female portion 204 with the complementary mating portion of the male module.

The drill collar 202 can also house a wire-carrying hollow tube 206, which can include a terminal end portion 208, a coiled or helical portion 210 coupled to the terminal end portion 208, and a central portion 212 coupled to the helical portion 210. The drill collar 202 can also house an internal body or chassis 214, coupled to the central portion 212 of the tube 206, which can house functional or operative components of the female module 200, such as sensors, electronic or electrical components (electronic components being a subset of electric components), computers, reamers, stabilizers, flow diverters, etc.

The wire-carrying hollow tube 206 can be hollow, that is, it can include an internal passageway that extends through the tube 206, including through the terminal end portion 208, through helical portion 210, and through the central portion 212 thereof. The terminal end portion 208 of the tube 206 can include a plurality of electrical interconnects positioned thereon, such as on an external surface of the terminal end portion 208 or on an internal surface of the terminal end portion 208. The internal passageway extending through the tube 206 can have an inside diameter large enough to carry a plurality of wires, such as for data or power transmission, therethrough. A plurality of wires 220 can be electrically coupled to the electrical interconnects positioned on the terminal end portion 208 of the tube 206 and can extend from the interconnects through the terminal end portion 208, through the helical portion 210, through the central portion 212 of the hollow tube 206, and into the internal body 214, where the plurality of wires can be coupled to the functional or operative components of the female module 200. The wires can have some slack (e.g., not be taut) to allow for movement of the tube 206 during operation of the drill string 112.

The tube 206 can extend through an open space 216 within the female module 200. The open space 216 can carry the drilling fluid 126 through the female module 200 during operation of the drill string 112. The tube 206 can bend and otherwise deform within the open space 216 during operation of the drill string 112, such as in response to relative motion of other components of the bottomhole assembly 114 within the various modules of the bottomhole assembly 114, such as within drill collars of the drill string 112, as may be caused by motion of the drill string 112 (e.g., vibration due to drilling or mud pulse activities), shockwaves, pressure differentials or temperature differentials within the wellbore, or as may be caused by deviations of the drill string 112 from a straight-line configuration. In particular, the tube 206 can bend or otherwise deform to compensate for relative motion between the female portion 204 or the drill collar 202 in the region of the female portion 204 and the internal body 214 or the drill collar in the region of the internal body 214. For example, the helical portion 210 of the tube 206 can act as a spring and provides the tube 206 with a localized flexible portion or compliant structure that can deform and move about within the open space 216 relatively freely, such as by elongating under tension, contracting under compression, twisting under torsion, bending under bending loads, and moving about within the open space 216 (e.g., transversely to a central longitudinal axis of the drill string 112) as the drill string 112 bends or experiences sheer loads.

The drill collar 202 can also house a plurality of fins 218 which can be in contact with an outer surface of the tube 206 (such as an outer surface of the central portion 212 of the tube 206) and an inner surface of the drill collar 202 to stabilize and maintain the location of the tube 206 within the drill collar 202 (e.g., such that a central longitudinal axis of the drill collar 202 is coincident with a central longitudinal axis of the tube 206) while still allowing the drilling fluid 126 to pass through the open space 216 during operation of the drill string 112. The fins 218 can be radially-oriented sheets of material or struts spaced at regular intervals about a central longitudinal axis of the hollow tube 206, such as spaced at 180°, 120°, 90°, 72°, etc., such that large angular portions of the open space 216 remain open and available for the drilling fluid 126 to pass between the fins 218. The fins 218 can be rigidly fixed to the outer surface of the tube 206 and not rigidly fixed to the inner surface of the drill collar 202, or can be rigidly fixed to the inner surface of the drill collar 202 and not rigidly fixed to the outer surface of the tube 206, or can be rigidly fixed to both of the outer surface of the tube 206 and the inner surface of the drill collar 202. The fins 218 can be formed from a rigid material such as a metal, aluminum, steel, bronze, etc., and can be manufactured with close tolerances.

FIG. 3 illustrates a portion of a male module 250 of a bottomhole assembly, such as for use in the drill string 112 and bottomhole assembly 114. The portion of the male module 250 illustrated in FIG. 3 can be either a bottom end or a top end of the male module 250 when it is positioned within a wellbore for a drilling operation. Male module 250 includes a module coupler 252 and a module main body 254. The module main body 254 can include a female portion 262 of a male-female connection system at a terminal end thereof. The female portion 262 of the module main body 254 can be identical to the female portion 204 of the female module 200, such that each of these female portions can be complementary to a single male portion of a male-female connection system.

The module coupler 252 can include an outer shell or casing or drill collar crossover sub 256 having a first male portion 258 of a male-female connection system at a first end thereof and a second male portion 260 of a male-female connection system at a second end thereof. The male portions 258, 260 can be tapered such that their diameters increase in a direction toward a central portion of the module coupler 252, and can include threads on the respective outer surfaces thereof. The male portions 258, 260 can be identical to one another such that each of these male portions can be complementary to a single female portion of a male-female connection system. The male portions 258 and 260 can be complementary to the female portions 204 and 262, such that either end of the module coupler 252 can be coupled to either the female module 200 or the male module 250.

In the configuration illustrated in FIG. 3, the male portion 260 of the module coupler 252 is coupled to the female portion 262 of the module main body 254, such that the module coupler 252 and the module main body 254 collectively form the male module 250. In use, the module coupler 252 can be uncoupled from the module main body 254, such as to allow access to components within the module main body 254. An outer diameter of the drill collar crossover sub 256 of the module coupler 252 can be equal to an outer diameter of a drill collar of the module main body 254, such that the male module 250 can have a flush, continuous outer surface. The male module 250 includes a central open space 264 that extends through both the module coupler 252 and the module main body 254. The open space 264 can carry the drilling fluid 126 through the male module 250 during operation of the drill string 112. The male module 250 also includes a wire-carrying hollow tube 266 positioned within the open space 264 and extending from outside the module coupler 252, through the module coupler 252, and into the module main body 254, which can house functional or operative components of the male module 250, such as sensors, electronic or electrical components, computers, reamers, stabilizers, flow diverters, etc.

The tube 266 can bend and otherwise deform within the open space 264 during operation of the drill string 112, although to a lesser degree than the tube 206 can because the tube 266 does not include a coiled portion. A terminal end portion 268 of the hollow tube 266 can include a plurality of electrical interconnects positioned thereon, such as on an external surface of the terminal end portion 268, on an internal surface of the terminal end portion 268, or on an electrical coupling apparatus 270 coupled to the terminal end portion 268 of the hollow tube 266. The internal passageway extending through the tube 266 can have an inside diameter large enough to carry one or more wires, such as for data or power transmission, therethrough. A plurality of wires 274 can be electrically coupled to the electrical interconnects positioned at the terminal end portion 268 of the tube 266 and can extend from the interconnects through the hollow tube 266 into the module main body 254, where the plurality of wires can be coupled to the functional or operative components of the male module 250.

The drill collar crossover sub 256 can house a plurality of fins 272 which can be in contact with an outer surface of the hollow tube 266 and an inner surface of the drill collar crossover sub 256 to stabilize and maintain the location of the tube 266 within the drill collar crossover sub 256 while still allowing the drilling fluid 126 to pass through the open space 264 during operation of the drill string 112. The fins 272 can be radially-oriented sheets of material or struts spaced at regular intervals about a central longitudinal axis of the hollow tube 266, such as spaced at 180°, 120°, 90°, 72°, etc., such that large angular portions of the open space 264 remain open and available for the drilling fluid 126 to pass between the fins 272. The fins 272 can be rigidly fixed to the outer surface of the tube 266 and not rigidly fixed to the inner surface of the drill collar crossover sub 256, or can be rigidly fixed to the inner surface of the drill collar crossover sub 256 and not rigidly fixed to the outer surface of the tube 266, or can be rigidly fixed to both of the outer surface of the tube 266 and the inner surface of the drill collar crossover sub 256. The fins 218 can be formed from a rigid material such as a metal, aluminum-bronze, steel, etc., and can be manufactured with close tolerances.

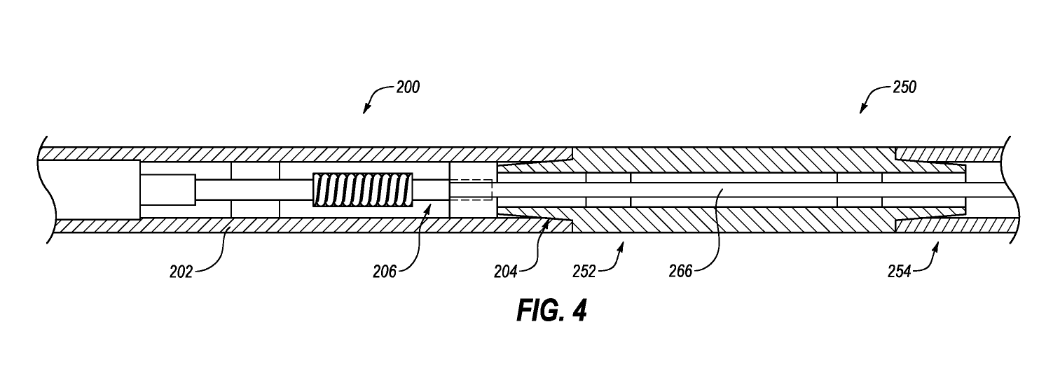

FIG. 4 illustrates a portion of a bottomhole assembly such as bottomhole assembly 114 including the female module 200 coupled to the male module 250, with the female portion 204 mated to the male portion 258. To couple the female module 200 to the male module 250 as illustrated in FIG. 4, the threads of the male portion 258 can be brought into proximity with the threads of the female portion 204, for example, such that the electrical coupling apparatus 270 is positioned within the female portion 204. The male portion 258 can be advanced toward and into the female portion 204 until the threads of the male portion 258 engage with the threads of the female portion 204, at which point, the terminal end portion 268 of the hollow tube 266 and the electrical coupling apparatus 270 have begun to engage with the terminal end portion 208 of the hollow tube 206, and at which point the electrical interconnects of the terminal end portion 268 and electrical coupling apparatus 270 have begun to engage with the electrical interconnects of the terminal end portion 208. The electrical coupling apparatus 270 can include a guide fin assembly having a plurality of fins similar to the fins 218 or 272 to allow the drilling fluid 126 to flow through the electrical coupling apparatus 270 during a drilling operation.

Electrical engagement of the electrical interconnects of the female module 200 and the electrical interconnects of the male module 250 can be achieved using any suitable multi-contact electrical connector assemblies. For example, connector assemblies such as those described in U.S. Pat. No. 7,074,064 and U.S. patent application Ser. No. 14/717,412, both of which are hereby incorporated herein by reference in their entireties, and in particular for what they teach regarding electrical connector assemblies, can be used to ensure engagement of the interconnects of the female and male modules 200, 250. Use of multi-contact electrical connector assemblies can increase bandwidth and decrease latency associated with communication, as well as increase power transfer capabilities between, drill string modules such as female and male modules 200, 250.

Once the threads of the male portion 258 engage with the threads of the female portion 204, the female and male modules 200, 250 can be rotated with respect to each other to draw the male portion 258 further into the female portion 204 and to complete the electrical connection of the interconnects of the female and male modules 200, 250. When the drill string 112 including the coupled female and male modules 200, 250 is used to drill a wellbore, data and power can be transferred between the modules 200, 250 to improve the progress of the drilling operation. For example, data regarding the location of the drill string 112 and properties of the earth being drilled can be shared between the modules 200, 250.

In some embodiments, the drill string 112 can include multiple female modules 200 and multiple male modules 250. For example, a single, repeatable module can have a first end matching that of the female module 200 described above and a second end matching that of the male module 250 described above. In such an embodiment, the male end of a first repeatable module can be coupled to the female end of a second repeatable module, and the male end of the second repeatable module can be coupled to the female end of a third repeatable module, etc., until a drill string of suitable or desirable length has been formed. Such repeatable modules can be used throughout the bottomhole assembly 114 but not the rest of the drill string 112, or throughout the entirety of the drill string 112.

In use, drill strings encounter many stresses, including those resulting from high pressures in the drilling fluid 126, those resulting from vibrations caused by the drill bit 105 cutting into the earth, and those caused by the drill string 112 conforming to curves or other irregularities in the wellbore. These stresses and other stresses can cause relative motion of many of the components within the drill string 112. In some cases relative motion between components can cause damage to electrical components and especially electrical connections and seal assemblies, such as those between modules, within the drill string 112, or within the bottomhole assembly 114. The helical portion 210 of the hollow tube 206 decouples the relative motion between electrical assemblies in adjacent drill string or bottomhole assembly modules with the electrical connections and seals.

FIG. 4 illustrates that when the female module 200 is coupled to the male module 250, the wire-carrying tube 206 and the wire-carrying tube 266 can be coupled to one another to form a single wire-carrying tube extending from the internal body 214 housing the functional or operative components of the female module 200 to an internal body (not shown) housing the functional or operative components of the male module 250. This single wire-carrying tube can carry a plurality of wires directly from functional or operative components (e.g., electronic or electrical components) of the female module 200 directly to functional or operative components (e.g., electronic or electrical components) of the male module 250.

Further, the entire lengths of the tube 206 and the tube 266 can be physically decoupled from (such that they are not rigidly coupled to) the drill collar 202, the drill collar crossover sub 256, and a drill collar of the module main body 254, such that motions or relative motions of, and forces or stresses induces within, the drill collars, are not directly transferred to any portion of the tube 206 or tube 266 and therefore are not directly transferred to the electrical interconnections between the modules 200, 250 or the elements sealing the electrical interconnections. The fins 218 and 272 can act to maintain the position of the tubes 206, 266 at the center of the drill string 112 without rigidly coupling the tubes 206, 266 to the drill collars or drill collar crossover subs. The motions or relative motions, and the forces or stresses, may be indirectly transferred to the tube 206 or tube 266 through the internal bodies (e.g., 214) of the modules 200, 250 to which the tubes 206, 266 are connected. Such indirectly transferred motions and forces can be readily compensated for by the flexibility of the helical portion 210 of the tube 206.

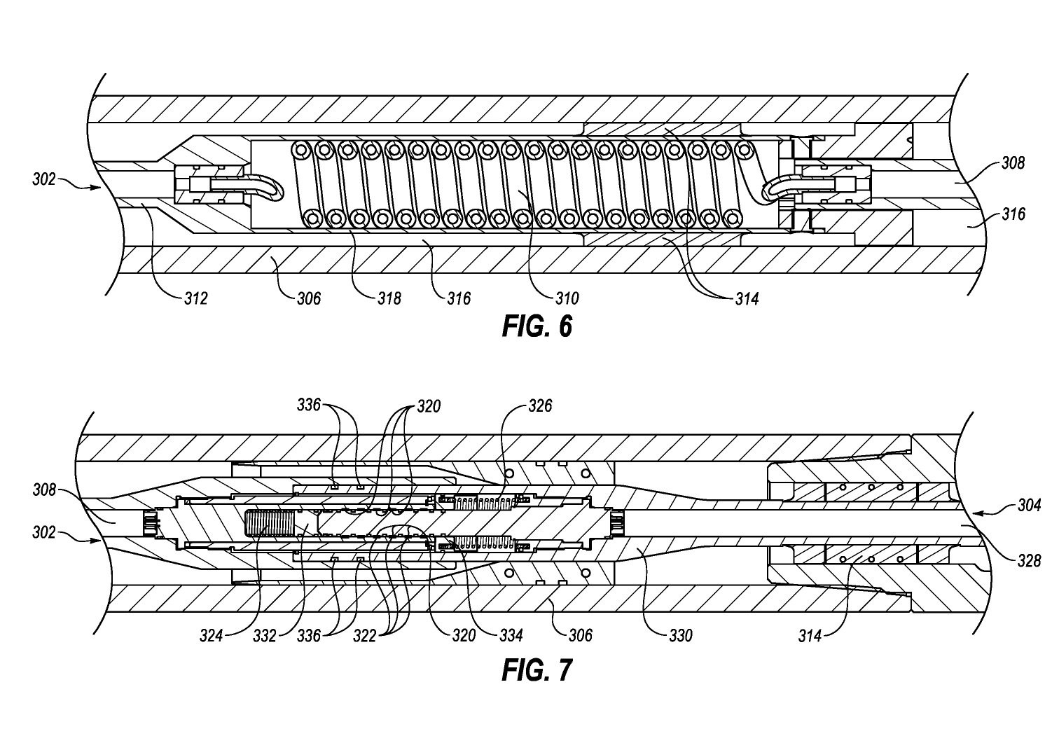

This configuration allows the helical portion 210 of the tube 206 to compensate for substantially all of the relative motion and associated forces arising between the end of the tube 206 in the female module 200 and the end of the tube 266 in the male module 250. This configuration can thereby arrest relative motion between the terminal end portion 208 of the tube 206 and the terminal end portion 268 of the tube 266, between the electrical interconnects of the female module 200 and of the male module 250, and between elements sealing these electrical interconnects. Thus, static, rather than dynamic sealing elements (e.g., 336, illustrated in FIG. 7) can be used to seal the terminal end portion 208 to the terminal end portion 268 and to seal the electrical interconnections between the female module 200 and the male module 250. Static sealing elements 336 are more reliable than dynamic sealing elements, especially in harsh downhole conditions.

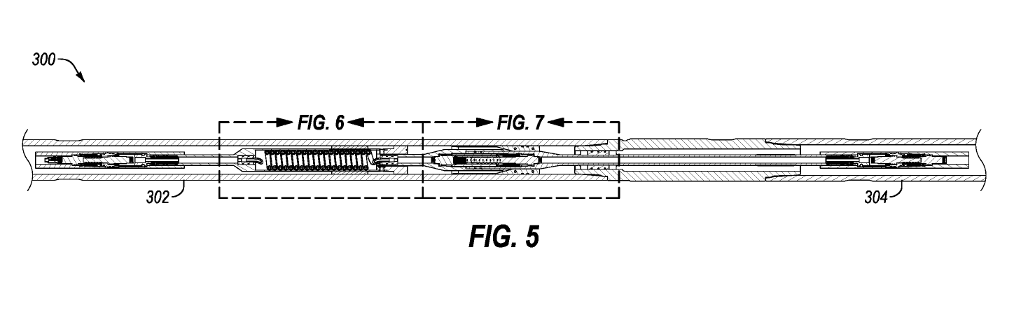

FIG. 5 illustrates a portion of a drill string bottomhole assembly 300, such as for use in the drill string 112. The portion of the drill string 300 includes a female module 302 similar to the female module 200 and a male module 304 similar to the male module 250. The portion of the drill string 300 can include various features of the female and male modules 200, 250 described above, and the following discussion focuses on differences between the modules 200, 250 and the modules 302, 304.

FIG. 6 illustrates a portion of the female module 302 in greater detail. The female module 302 includes an outer drill collar 306 that encloses and houses various other components of the female module 302. For example, the drill collar 306 houses a wire-carrying hollow tube including a terminal end portion 308, a coiled or helical portion 310, and a central portion 312. The helical portion 310 of the hollow tube is enclosed within an internal sheath 318, which can prevent drilling fluid 126 flowing through an open space 316 within the female module 302 from coming into contact with the helical portion 310 during operation of the portion of the drill string 300. This can prevent or reduce damage or wear on the helical portion 310 during operation, and can reduce resistance to the flow of the drilling fluid 126 through the portion of the drill string bottomhole assembly 300. Fins 314 can be positioned in contact with an outer surface of the sheath 318 and an inner surface of the drill collar 306 to stabilize and maintain the location of the helical portion 310 of the tube within the drill collar 306.

FIG. 7 illustrates the electrical interconnection features of the female module 302 and the male module 304 in greater detail. The female module 302 includes electrical interconnects 322 mounted on an inner surface of the terminal end portion 308 of the tube extending through the female module 302, and the male module 304 includes electrical interconnects 320 mounted on an outer surface of a distal portion of a hollow tube 328 extending through the male module 304. A pair of springs 324, 326 are positioned within the terminal end portion 308 of the tube extending through the female module 302 and within an electrical coupling apparatus 330 coupled to a terminal end portion of the hollow tube 328 extending through the male module 304, respectively.

The springs 324, 326 bias wiper elements 332, 334 of the terminal end portion 308 and the electrical coupling apparatus 330, respectively, toward respective openings thereof, so as to prevent contamination of those components prior to engaging the electrical interconnects 320, 322. When the electrical interconnects 320, 322 are brought together, the springs 324, 326 are compressed and the wiper elements 332, 334 are pushed into their respective openings and over the electrical interconnects 322, 320, respectively, thereby wiping the interconnects 320, 322 clean of contamination. In some cases, the wiper elements 332, 334 can include one or more sealing o-rings protruding from an external surface thereof to wipe the interconnects 320, 322 clean of contamination as the springs 324, 326 are compressed. Additional details and designs are available in the previously mentioned U.S. Pat. No. 7,074,064 and U.S. patent application Ser. No. 14/717,412.

Such an electrical interconnection system can interconnect single or multiple wires, for example, 1, 2, 3, 4, 5, 6, or more wires, between drill string modules. The wires can have any suitable gauge, and can have different gauges from one another. For example, the electrical interconnection system can couple 2 16 AWG wires and 4 20 AWG wires between drill string modules. The wires can be provided in twisted pairs, can be shielded, or have any other suitable characteristics. The electrical interconnection systems described herein can be used without being filled with an oil or a dielectric fluid. Such electrical interconnection systems can automate the interconnection process and reduce human interaction with the interconnects prior to their engagement.

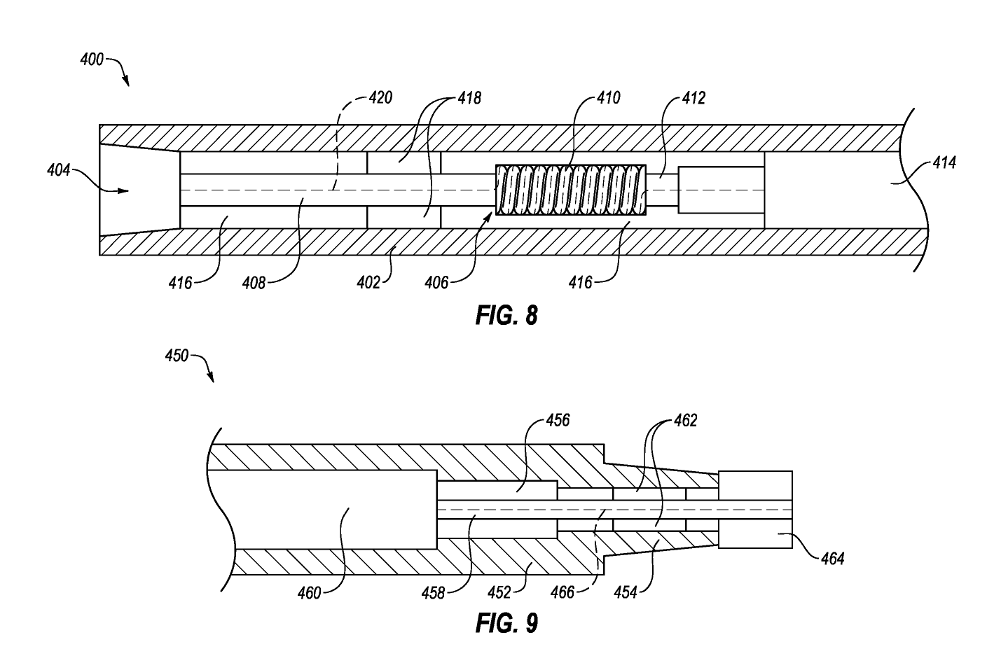

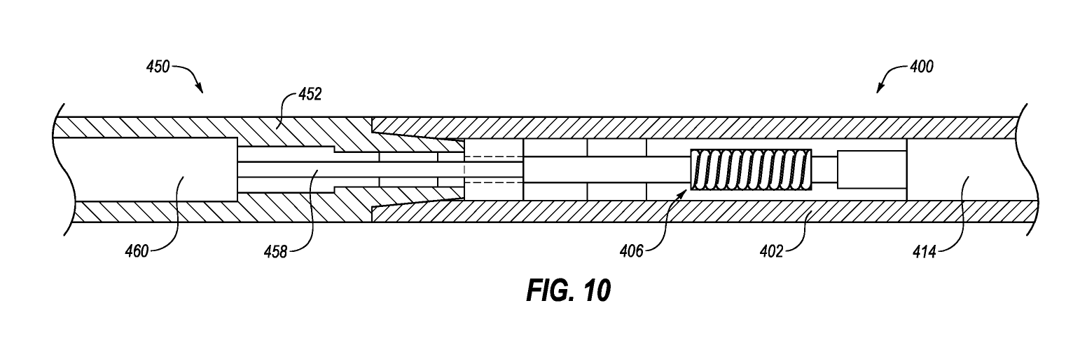

FIG. 8 illustrates a female module 400 similar to female module 200 and FIG. 9 illustrates a male module 450 similar to male module 250, such as for use in the drill string 112. FIG. 10 illustrates a portion of the drill string 112 including the female module 400 coupled to the male module 450. The modules 400, 450 can include various features of the modules 200, 250 described above, and the following discussion focuses on differences between the modules 200, 250 and the modules 400, 450.

Female module 400 includes an outer shell or casing or drill collar 402 which houses other components of the module 400. For example, the drill collar 402 can house a female portion 404 of a male-female connection system at a first end of the female module 400. The drill collar 402 can also house a wire-carrying hollow tube 406 which can carry a plurality of wires 420, and which can include a terminal end portion 408, a coiled or helical portion 410 coupled to the terminal end portion 408, and a central portion 412 coupled to the helical portion 410. The drill collar 402 can also house an internal body 414, coupled to the central portion 412 of the tube 406, which can house functional or operative components of the female module 400, such as sensors, electronic or electrical components, computers, reamers, stabilizers, flow diverters, etc.

The tube 406 can extend through an open space 416 within the female module 400. The drill collar 402 can also house a plurality of fins 418 which can be positioned in contact with an outer surface of the tube 406 (such as an outer surface of the terminal end portion 408 of the tube 406) and an inner surface of the drill collar 402 to stabilize and maintain the location of the tube 406 within the drill collar 402 while still allowing drilling fluid 126 to pass through the open space 416 during operation of the drill string 112.

The male module 450 includes an outer shell or casing or drill collar 452 having a male portion 454 of a male-female connection system at a first end thereof. The male portion 454 can be complementary to the female portion 404, such that the male portion 454 can be coupled to the female portion 404 to couple the male module 450 to the female module 400. The male module 450 includes a central open space 456 that can carry the drilling fluid 126 through the male module 450 during operation of the drill string 112.

The male module 450 also includes a wire-carrying hollow tube 458 which can carry a plurality of wires 466, and which can extend from outside the first end of the male module 450 where it is coupled to an electrical coupling apparatus 464, through the open space 456, and into an internal body 460 housed within the drill collar 452. The internal body 460 can house functional or operative components of the male module 450, such as sensors, electronic or electrical components, computers, reamers, stabilizers, flow diverters, etc. Further, the drill collar 452 can house a plurality of fins 462 which can be in contact with an outer surface of the hollow tube 458 and an inner surface of the drill collar 452 to stabilize and maintain the location of the tube 458 within the drill collar 452 while still allowing the drilling fluid 126 to pass through the open space 456 during operation of the drill string 112.

The male module 450 does not include a module coupler and a module main body as the male module 250 does. As a result, a drill string including a male module 450 has one fewer male-female connections (relative weak points in a drill string) than does a drill string including a male module 250.

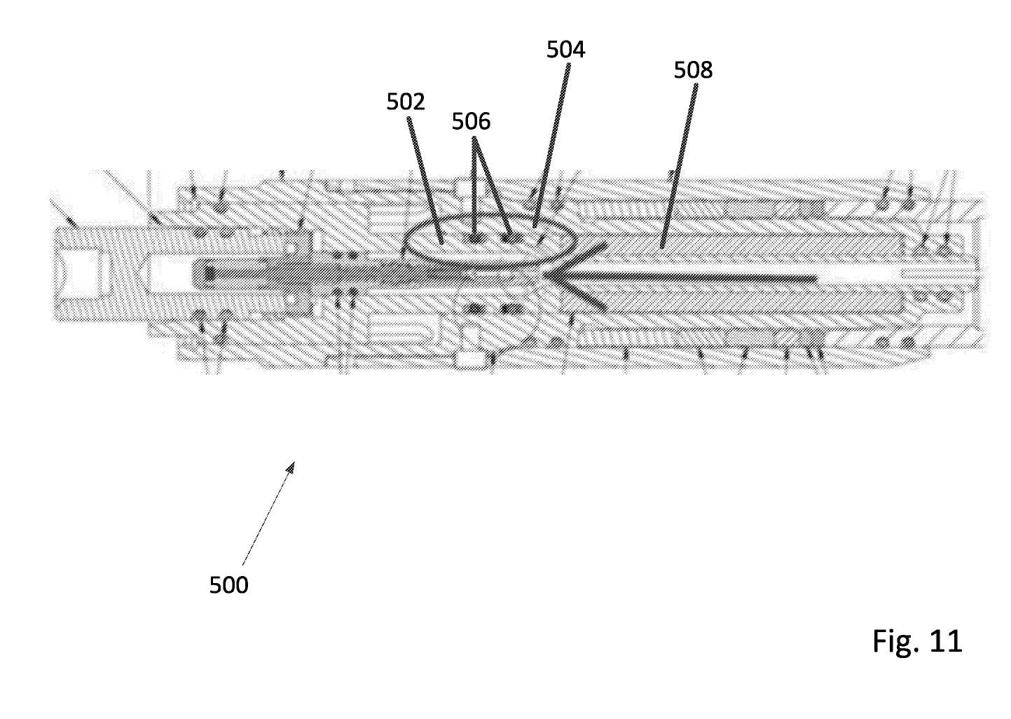

As shown in FIG. 11, in some embodiments, any of the hollow tubes described herein can include a telescopic joint 500 in place of a helical portion. For example, the telescopic joint 500 can include a first, inner portion 502 of the joint 500 and a second, outer portion 504 of the joint 500. The inner portion 502 can translate longitudinally within the outer portion 504 to compensate for substantially all of the relative motion and associated forces arising between the ends of the respective hollow tubes, as described above for the helical portion 210. The telescopic joint 500 can include one or more dynamic sealing elements 506 to seal the inner and outer portions 502, 504 to one another, and a spring 508 to bias the inner portion 502 to translate out of and away from the outer portion 504.

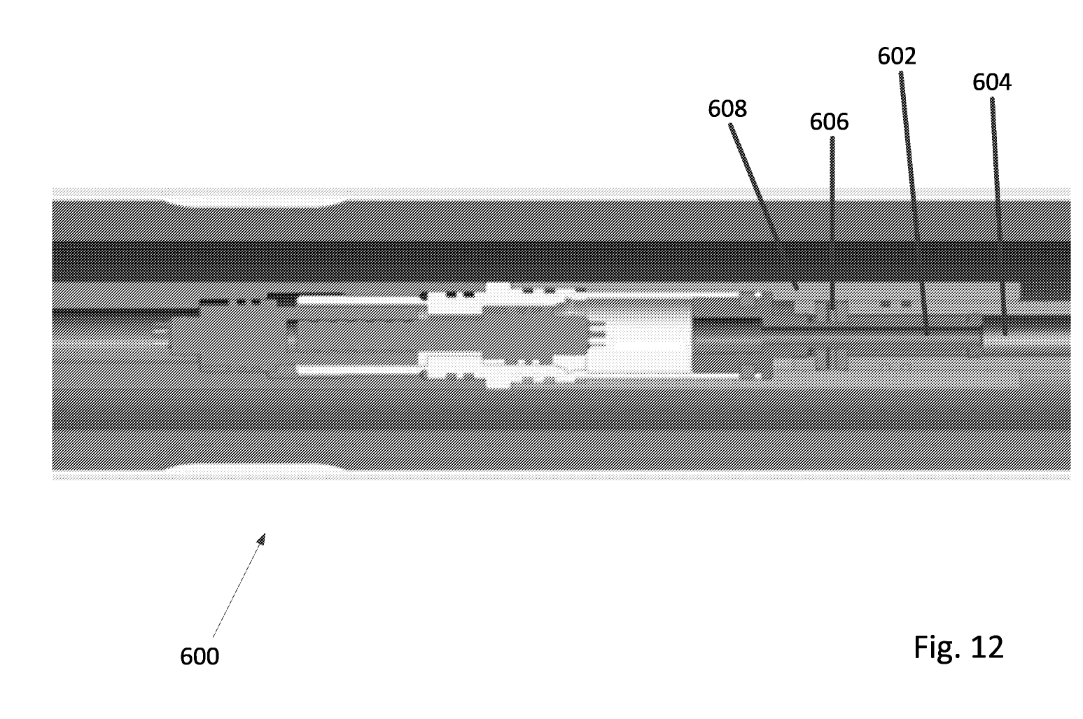

As shown in FIG. 12, in some embodiments, any one of the hollow tubes described herein, or any one of the drill collars described herein, can include a length adjustment mechanism 600. The length adjustment mechanism 600 can be used to adjust a length of a tube or a drill collar, such as to accommodate variations in length arising, for example, from connection reworks or recuts performed in response to damage or wear to the components. The length adjustment mechanism 600 can include an inner hollow shaft 602 having a threaded external surface and a pair of longitudinally-extending keyways formed in its external surface. The mechanism 600 can also include an outer hollow shaft 604 having a threaded internal surface complementary to the threaded outer surface of the inner hollow shaft 602 and a pair of openings formed through an end portion thereof. The mechanism 600 can also include a pair of alignment keys 606 and an outer, pressure-tight sealing sleeve 608. To use the mechanism 600, the threads of the inner hollow shaft 602 can be engaged with the threads of the outer hollow shaft 604 and the two shafts 602, 604 can be rotated with respect to one another until they form a tube or collar having a desired length. The alignment keys 606 can then be positioned to extend through the openings at the end portion of the outer hollow shaft 604 and into the keyways of the inner hollow shaft 602 to rotationally lock the inner and outer hollow shafts 602, 604 to one another. The outer sealing sleeve 608 can then be positioned over the shafts 602, 604, and the alignment keys 606 to lock the alignment keys 606 and the rest of the mechanism 600 in position.

A few example embodiments have been described in detail above; however, those skilled in the art will readily appreciate that many modifications are possible in the example embodiments without materially departing from the scope of the present disclosure or the appended claims. Accordingly, such modifications are intended to be included in the scope of this disclosure. Likewise, while the disclosure herein contains many specifics, these specifics should not be construed as limiting the scope of the disclosure or of any of the appended claims, but merely as providing information pertinent to one or more specific embodiments that may fall within the scope of the disclosure and the appended claims. Any described features from the various embodiments disclosed may be employed in combination. In addition, other embodiments of the present disclosure may also be devised which lie within the scope of the disclosure and the appended claims. Additions, deletions and modifications to the embodiments that fall within the meaning and scopes of the claims are to be embraced by the claims.

Certain embodiments and features may have been described using a set of numerical upper limits and a set of numerical lower limits. It should be appreciated that ranges including the combination of any two values, e.g., the combination of any lower value with any upper value, the combination of any two lower values, or the combination of any two upper values are contemplated. Certain lower limits, upper limits and ranges may appear in one or more claims below. Numerical values are “about” or “approximately” the indicated value, and take into account experimental error, tolerances in manufacturing or operational processes, and other variations that would be expected by a person having ordinary skill in the art.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include other possible embodiments along with the full scope of equivalents to which such claims are entitled. Accordingly, the claims are not limited by the disclosure.

1. A compliant module connection system, comprising:
a first module including a first drill collar, a first electric component, a first hollow tube, a first wire that is electrically coupled to the first electrical component and that extends through the first hollow tube, and a first portion of a module connection system;
a second module including a second drill collar, a second electric component, a second hollow tube, a second wire that is electrically coupled to the second electrical component and that extends through the second hollow tube, and a second portion of the module connection system;
the second portion of the module connection system complementary to the first portion of the module connection system; and
the first hollow tube including a helical portion of the first hollow tube.

2. The system of claim 1, wherein the first portion of the module connection system is a male portion of a male-female module connection system and the second portion of the module connection system is a female portion of the male-female module connection system.

3. The system of claim 1, wherein the first portion of the module connection system is a female portion of a male-female module connection system and the second portion of the module connection system is a male portion of the male-female module connection system.

4. The system of claim 1 wherein the first module includes a third electric component and a third wire that is electrically coupled to the third electric component and that extends through the first hollow tube.

5. The system of claim 1, wherein when the first portion of the module connection system is engaged with the second portion of the module connection system, the first wire is electrically coupled to the second wire.

6. The system of claim 1, wherein the first module is a first drill string module and the second module is a second drill string module.

7. A compliant module connection system, comprising:
a first module including a first drill collar, a first electric component, a first hollow tube, a first wire that is electrically coupled to the first electrical component and that extends through the first hollow tube, and a first portion of a module connection system;
a second module including a second drill collar, a second electric component, a second hollow tube, a second wire that is electrically coupled to the second electrical component and that extends through the second hollow tube, and a second portion of the module connection system;
the second portion of the module connection system complementary to the first portion of the module connection system; and
the first hollow tube including a telescopic joint of the first hollow tube.

8. A method of making compliant module connections, comprising:
positioning a first electric component within a first drill collar of a first module;
electrically coupling a first wire to the first electric component;
running the first wire through a first hollow tube;
positioning a second electric component within a second drill collar of a second module;
electrically coupling a second wire to the second electric component;
running the second wire through a second hollow tube; and
electrically coupling the first wire to the second wire by physically connecting the first module to the second module.

9. The method of claim 8, wherein running the first wire through a first hollow tube includes running the first wire through a helical portion of the first hollow tube.

10. The method of claim 8, wherein running the first wire through a first hollow tube includes running the first wire through a telescopic joint of the first hollow tube.

11. The method of claim 8, wherein physically connecting the first module to the second module includes mating a male portion of the first module with a female portion of the second module.

12. The method of claim 8, further comprising:
positioning a third electric component within the first drill collar;
electrically coupling a third wire to the third electric component; and
running the third wire through the first hollow tube.

13. The method of claim 8, wherein the first module is a first drill string module and the second module is a second drill string module.

14. The method of claim 13, further comprising tripping the first drill string module and the second drill string module into a wellbore.
